(19) United States
(12) Patent Application Publication
(10) Pub. No.: US 2021/0082045 A1
(43) Pub. Date: Mar. 18, 2021

(54) SMART CONTRACT FOR COPY TRADING

(71) Applicants: Johnathan Alexander ASSIA, Savyon (IL); ETORO GROUP LTD., Tortola (VG)

(72) Inventors: Johnathan Alexander ASSIA, Savyon (IL); Paz DIAMANT, Givat Shmuel (IL)

(21) Appl. No.: 16/613,490

(22) PCT Filed: May 30, 2018
(86) PCT No.: PCT/IL2018/050591

§ 371 Date: Nov. 14, 2019

Related U.S. Application Data
(60) Provisional application No. 62/513,473, filed on Jun. 1, 2017.
(60) Provisional application No. 62/612,637, filed on Jan. 1, 2018.

(51) Int. Cl. G06Q 40/04; G06Q 20/38; G06Q 10/10; G06Q 20/06; G06F 16/23

(52) U.S. Cl. CPC G06Q 40/04; G06Q 20/389; G06Q 2220/00; G06Q 20/0655; G06F 16/2379; G06Q 10/10

(57) ABSTRACT

A method, computer, and computer program product for facilitating automatic trading of financial instruments in a computerized trading network in which trades are recorded to a blockchain data structure and in which each trader is associated with one or more blockchain addresses, the comprising the steps of: i) obtaining data indicative of a first trader; ii) obtaining data indicative of at least one blockchain address associated with the first trader; iii) monitoring the trades recorded to the blockchain data structure to identify trades associated with the at least one blockchain address of the first trader, thereby determining when a first trade has been executed for the first trader; and iv) upon determining that a first trade has been executed for the first trader, facilitating, using a smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

### TECHNICAL FIELD

The presently disclosed subject matter relates to facilitating copy trading of financial instruments, and particularly to copy trading implemented by smart contracts on a blockchain.

### BACKGROUND

A blockchain is a distributed database that maintains a continuously growing list of records, called blocks, secured from tampering and revision. Each block contains a timestamp and a link to a previous block. By design, blockchains are inherently resistant to modification of the data—once recorded, the data in a block cannot be altered retroactively. Through the use of a peer-to-peer network and a distributed timestamping server, a blockchain database is managed autonomously.

Smart contracts are computer protocols that run on a blockchain that facilitate, verify, or enforce the negotiation or performance of a contract, or that make a contractual clause unnecessary. Smart contracts can be used to transfer one or more types of cryptocurrency between blockchain addresses when certain conditions are satisfied. As such, smart contracts can be programmed to facilitate the secure exchange of goods and/or services between users of a decentralized network, thereby obviating the need for a trusted third party to manage such exchanges.

Copy trading refers to the capability of copying a given trader's trading positions by entering and/or exiting corresponding trading positions automatically whenever the given trader enters and/or exits trading positions.

United States Patent Publication No. 2015/0332395 discloses security settlement in financial markets and cryptographic currencies. The cryptographic currency protocol supports a virtual wallet that, in various embodiments, is a security and cash account for storing and managing the cryptographic currency. Opening a transaction via the virtual wallet to transfer the cryptographic currency is a strong guarantee of the availability of funds in the virtual wallet because, e.g., funds are not transacted unless the commit phase is successful.

United States Patent Publication No. 2016/0292672 discloses a computer system that communicates with a distributed blockchain computing system that includes multiple computing nodes. The exchange stores an order book and a plurality of digital wallets associated with different clients. The computer system receives new data transaction requests that are added to the order book. A match is identified between data transaction requests and hashes associated with the digital wallets associated with the respective data transaction requests are generated. The counterparties receive the hashes of the other party along with information on the match and each party causes blockchain transactions to be added to the blockchain of the blockchain computing system. The computing system then monitors the blockchain to determine if both sides of the match has been added to the blockchain.

United States Patent Publication No. 2017/0011460 discloses a securities trading system that utilizes a distributed blockchain ledger to conduct security transactions. Users are provided with cryptographic wallets that enable the users to access a peer-to-peer network of computing nodes on which the distributed blockchain ledger is managed. The securities made available through the network may be stored directly on the blockchain ledger itself. Smart contracts may be utilized to transfer the securities among the users and to verify that all transactions are in compliance with applicable regulatory rules and other restrictions.

The references cited above teach background information that may be applicable to the presently disclosed subject matter. Therefore the full contents of these publications are incorporated by reference herein where appropriate for appropriate teachings of additional or alternative details, features and/or technical background.

### GENERAL DESCRIPTION

According to one aspect of the presently disclosed subject matter there is provided a computer configured for facilitating automatic trading of financial instruments in a computerized trading network in which trades are recorded to a blockchain data structure and in which each trader is associated with one or more blockchain addresses, the computer comprising a memory and a processor operatively coupled to the memory and configured to: i) obtain from the memory data indicative of a first trader; ii) obtain data indicative of at least one blockchain address associated with the first trader; iii) monitor the trades recorded to the blockchain data structure to identify trades associated with the at least one blockchain address of the first trader, thereby determining when a first trade has been executed for the first trader; and iv) upon determining that a first trade has been executed for the first trader, facilitate, using a smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

In addition to the above features, the system according to this aspect of the presently disclosed subject matter can comprise one or more of features (i) to (vii) listed below, in any desired combination or permutation which is technically possible:

(i) the automatic execution of a respective second trade is performed only upon the first trade meeting predefined criteria obtained from the respective second trader;

(ii) the facilitating further includes facilitating, using the smart contract, the determination, for each second trader associated with the first trader, whether the first trade meets the predefined criteria obtained from the respective second trader;

(iii) one or more of the second traders are each associated with one or more third traders, and wherein upon facilitating execution of a second trade for a second trader, one or more steps of the method are repeated with the second trader now being the first trader and the one or more third traders now being the one or more second traders;

(iv) the processor is configured to use the smart contract to register the one or more second traders to copy trades of the first trader;

(v) the smart contract registers a given second trader only upon obtaining value from the given second trader;

(vi) the processor is configured to use the smart contract to provide value to the first trader upon the execution of one or more second trades; and

(vii) the value is in the form of cryptocurrency.

According to another aspect of the presently disclosed subject matter there is provided a computer implemented method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) monitoring the trades recorded to the blockchain data structure to identify trades associated with the at least one blockchain address of the first trader, thereby determining when a first trade has been executed for the first trader; and iv) upon determining that a first trade has been executed for the first trader, facilitating using a smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) monitoring the trades recorded to the blockchain data structure to identify trades associated with the at least one blockchain address of the first trader, thereby determining when a first trade has been executed for the first trader; and iv) upon determining that a first trade has been executed for the first trader, facilitating, using a smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer configured for facilitating automatic trading of financial instruments in a computerized trading network in which trades are recorded to a blockchain data structure and in which each trader is associated with one or more blockchain addresses, comprising: a memory; and a processor operatively coupled to the memory and configured to: i) obtain from the memory data indicative of a first trader; ii) obtain data indicative of at least one blockchain address associated with the first trader; iii) monitor the trades recorded to the blockchain data structure to identify trades associated with the at least one blockchain address of the first trader, thereby determining when a first trade has been executed for the first trader; iv) determine one or more second traders associated with said first trader; and v) facilitate, using a smart contract associated with the blockchain data structure, the automatic execution of a respective second trade for each of the one or more associated second traders and recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer implemented method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) monitoring the trades recorded to the blockchain data structure to identify trades associated with the at least one blockchain address of the first trader, thereby determining when a first trade has been executed for the first trader; iv) determining one or more second traders associated with said first trader; and v) facilitating, using a smart contract associated with the blockchain data structure, the automatic execution of a respective second trade for each of the one or more associated second traders and recording of each respective second trade to the blockchain data structure in association with a blockchain address of the respective second trader.

This aspect of the disclosed subject matter can comprise one or more of features (i) to (vii) listed above with respect, to the system, mutatis mutandis, in any desired combination or permutation which is technically possible.

According to another aspect of the presently disclosed subject matter there is provided a computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) monitoring the trades recorded to the blockchain data structure to identify trades associated with the at least one blockchain address of the first trader, thereby determining when a first trade has been executed for the first trader; iv) determining one or more second traders associated with said first trader; and v) facilitating, using a smart contract associated with the blockchain data structure, the automatic execution of a respective second trade for each of the one or more associated second traders and recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer configured for facilitating automatic trading of financial instruments in a computerized trading network in which trades are recorded to a blockchain data structure and in which each trader is associated with one or more blockchain addresses, comprising: a memory; and a processor operatively coupled to the memory and configured to: i) obtain from the memory data indicative of a first trader; ii) obtain data indicative of at least one blockchain address associated with the first trader; iii) facilitate execution of a first trade for the first trader, said facilitate including using a first smart contract to record the first trade to the blockchain data structure in association with the at least one blockchain address of the first trader; and iv) facilitate, using a second smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer implemented method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) facilitating execution of a first trade for the first trader, said facilitating including using a first smart contract to record the first trade to the blockchain data structure in association with the at least one blockchain address of the first trader; and iv) facilitating, using a second smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) facilitating execution of a first trade for the first trader, said facilitating including using a first smart contract to record the first trade to the blockchain data structure in association with the at least one blockchain address of the first trader; and iv) facilitating, using a second smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer configured for facilitating automatic trading of financial instruments in a computerized trading network in which trades are recorded to a blockchain data structure and in which each trader is associated with one or more blockchain addresses, comprising: a memory; and a processor operatively coupled to the memory and configured to: i) obtain from the memory data indicative of a first trader; ii) obtain data indicative of at least one blockchain address associated with the first trader; iii) facilitate execution of a first trade for the first trader, said facilitate including using a first smart contract to record the first trade to the blockchain data structure in association with the blockchain address of the first trader; iv) facilitate, using the first smart contract, the determination of one or more second traders which are associated with the first trader; and v) facilitate, using a second smart contract associated with the blockchain data structure, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer implemented method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) facilitating execution of a first trade for the first trader, said facilitating including using a first smart contract to record the first trade to the blockchain data structure in association with the blockchain address of the first trader; iv) facilitating, using the first smart contract, the determination of one or more second traders which are associated with the first trader; and v) facilitating, using a second smart contract associated with the blockchain data structure, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) facilitating execution of a first trade for the first trader, said facilitating including using a first smart contract to record the first trade to the blockchain data structure in association with the blockchain address of the first trader; iv) facilitating, using the first smart contract, the determination of one or more second traders which are associated with the first trader; and v) facilitating, using a second smart contract associated with the blockchain data structure, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer configured for facilitating automatic trading of financial instruments in a computerized trading network in which trades are recorded to a blockchain data structure and in which each trader is associated with one or more blockchain addresses, comprising: a memory; and a processor operatively coupled to the memory and configured to: i) obtain from the memory data indicative of a first trader; ii) obtain data indicative of at least one blockchain address associated with the first trader; iii) facilitate execution of a first trade for the first trader, said facilitate including using a first smart contract to record the first trade to the blockchain data structure in association with the blockchain address of the first trader; iv) facilitate, using the first smart contract, the determination of one or more second traders which are associated with the first trader; and v) facilitate, using a second smart contract associated with the blockchain data structure, the automatic execution of a respective second trade for each of said second traders, and recording of the respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer implemented method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) facilitating execution of a first trade for the first trader, said facilitating including using a first smart contract to record the first trade to the blockchain data structure in association with the blockchain address of the first trader; iv) facilitating, using the first smart contract, the determination of one or more second traders which are associated with the first trader; and v) facilitating, using a second smart contract associated with the blockchain data structure, the automatic execution of a respective second trade for each of said second traders, and recording of the respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) facilitating execution of a first trade for the first trader, said facilitating including using a first smart contract to record the first trade to the blockchain data structure in association with the blockchain address of the first trader; iv) facilitating, using the first smart contract, the determination of one or more second traders which are associated with the first trader; and v) facilitating, using a second smart contract associated with the blockchain data structure, the automatic execution of a respective second trade for each of said second traders, and recording of the respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer configured for facilitating automatic trading of financial instruments in a computerized trading network in which trades are recorded to a blockchain data structure and in which each trader is associated with one or more blockchain addresses, comprising: a memory; and a processor operatively coupled to the memory and configured to: i) obtain from the memory data indicative of a first trader; ii) obtain data indicative of at least one blockchain address associated with the first trader; iii) facilitate execution of a first trade for the first trader, said facilitate including using a smart contract to record the first trade to the blockchain data structure in association with the blockchain address of the first trader; and iv) facilitate, using the smart contract, the determination of one or more second traders which are associated with the first trader and, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer implemented method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) facilitating execution of a first trade for the first trader, said facilitating including using a smart contract to record the first trade to the blockchain data structure in association with the blockchain address of the first trader; and iv) facilitating, using the smart contract, the determination of one or more second traders which are associated with the first trader and, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

According to another aspect of the presently disclosed subject matter there is provided a computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising: i) obtaining from the memory data indicative of a first trader; ii) obtaining data indicative of at least one blockchain address associated with the first trader; iii) facilitating execution of a first trade for the first trader, said facilitating including using a smart contract to record the first trade to the blockchain data structure in association with the blockchain address of the first trader; and iv) facilitating, using the smart contract, the determination of one or more second traders which are associated with the first trader and, for each of said second traders, the automatic execution of a respective second trade and the recording of each respective second trade to the blockchain data structure in association with a blockchain address of the respective second trader.

This aspect of the disclosed subject matter can comprise one or more of features (i) to (vii) listed above with respect to the system, mutatis mutandis, in any desired combination or permutation which is technically possible.

### BRIEF DESCRIPTION OF THE DRAWINGS

In order to understand the invention and to see how it can be carried out in practice, embodiments will be described, by way of non-limiting examples, with reference to the accompanying drawings, in which:

FIG. 1A illustrates an example network environment for facilitating automatic trading of financial instruments in accordance with certain embodiments of the presently disclosed subject matter;

FIG. 1B illustrates an example computer configured for facilitating automatic trading of financial instruments in accordance with certain embodiments of the presently disclosed subject matter;

FIG. 1C illustrates an example trading platform configured for facilitating automatic trading of financial instruments in accordance with certain embodiments of the presently disclosed subject matter;

FIG. 2 illustrates a generalized flow-chart of an example of a sequence of operations that may be carried out for facilitating automatic trading of financial instruments in accordance with certain embodiments of the presently disclosed subject matter;

FIG. 3 illustrates a generalized flow-chart of facilitating automatic execution of a second trade in accordance with certain embodiments of the presently disclosed subject matter;

FIG. 4A illustrates a first example of facilitating automatic execution of a second trade in accordance with certain embodiments of the presently disclosed subject matter;

FIG. 4B illustrates a second example of facilitating automatic execution of a second trade in accordance with certain embodiments of the presently disclosed subject matter;

FIG. 4C illustrates a third example of facilitating automatic execution of a second trade in accordance with certain embodiments of the presently disclosed subject matter;

FIG. 5 illustrates a generalized flow-chart of an example of a sequence of operations that may be carried out for facilitating automatic trading of financial instruments in accordance with certain embodiments of the presently disclosed subject matter;

FIG. 6 illustrates a generalized flow-chart of facilitating automatic execution of a second trade in accordance with certain embodiments of the presently disclosed subject matter;

FIG. 7 illustrates a generalized flow-chart of registering a first trader in accordance with certain embodiments of the presently disclosed subject matter; and

FIG. 8 illustrates a generalized flow-chart of registering a second trader in accordance with certain embodiments of the presently disclosed subject matter;

### DETAILED DESCRIPTION

In the following detailed description, numerous specific details are set forth in order to provide a thorough understanding of the invention. However, it will be understood by those skilled in the art that the presently disclosed subject matter may be practiced without these specific details. In other instances, well-known methods, procedures, components and circuits have not been described in detail so as not to obscure the presently disclosed subject matter.

Unless specifically stated otherwise, as apparent from the following discussions, it is appreciated that throughout the specification discussions utilizing tennis such as “determining”, “facilitating”, “obtaining”, “monitoring”, “recording”, or the like, refer to the action(s) and/or process(es) of a computer that manipulate and/or transform data into other data, said data represented as physical, such as electronic, quantities and/or said data representing the physical objects. The term “computer” should be expansively construed to cover any kind of hardware-based electronic device with data processing capabilities including, by way of non-limiting example, personal computers, laptops, tablets, smartphones, and the like.

The terms “non-transitory memory” and “non-transitory storage medium” used herein should be expansively construed to cover any volatile or non-volatile computer memory suitable to the presently disclosed subject matter.

The operations in accordance with the teachings herein may be performed by a computer specially constructed for the desired purposes or by a general-purpose computer specially configured for the desired purpose by a computer program stored in a non-transitory computer-readable storage medium.

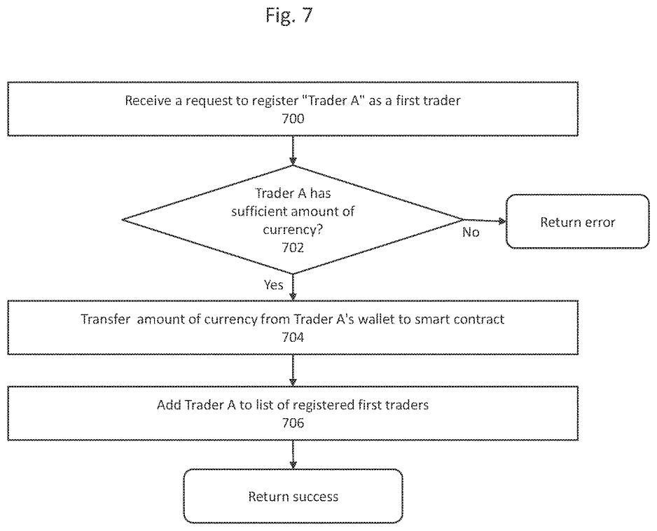

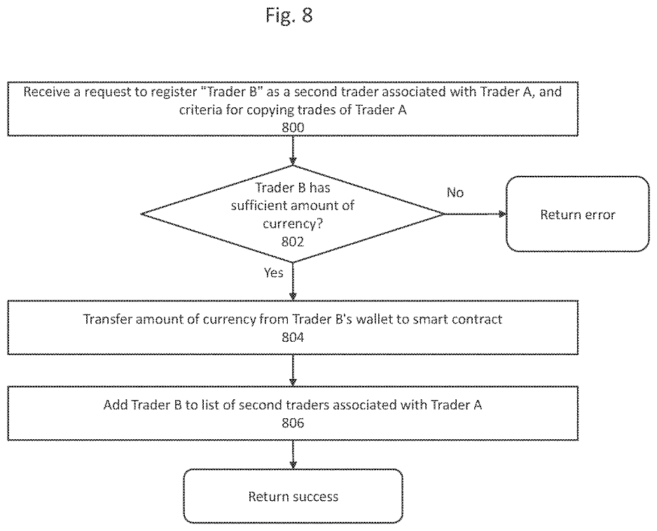

Throughout the following description, the term “first trader” is used to refer to a trader that is desirous of being copied (e.g. a trader that registers to be “copied” by other traders, as will be detailed below with reference to FIG. 7 illustrating a generalized flow-chart of registering a first trader in accordance with certain embodiments of the presently disclosed subject matter), while the term “second trader” is used to refer to a trader that is desirous of copying. (e.g. a trader that registers to “copy” another trader, as will be detailed below with reference to FIG. 8 illustrating a generalized flow-chart of registering a second trader in accordance with certain embodiments of the presently disclosed subject matter).

The term “copy trade”, should be understood to include a proportional trading position which is executed for a second trader based on a trade made by a first trader, taking into account the funds allocated to the trade by the first trader as a percentage of available funds and according to the funds that the second trader has allocated towards the copy trade. To illustrate by way of non-limiting example, Bob, a first trader, has $100 cash available for trading and invests half of this amount ($50) to buy shares of XYZ Corp. Andre, a second trader that copies Bob, has allocated $200 of his available funds to copy trades made by Bob. Therefore, upon Bob's trade in XYZ Corp., a copy trade would be executed for Andre, in which $100 worth of shares of XYZ Corp (being half of the allocated $200) would be purchased automatically for Andre.

Embodiments of the presently disclosed subject matter are not described with reference to any particular programming language. It will be appreciated that a variety of programming languages may be used to implement the teachings of the presently disclosed subject matter as described herein.

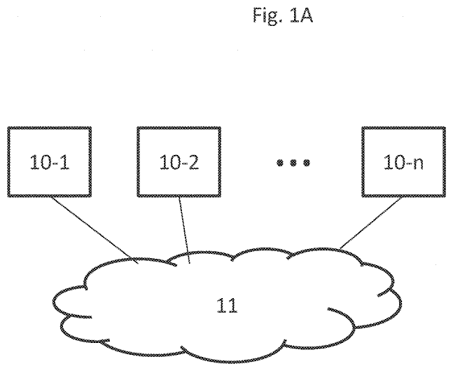

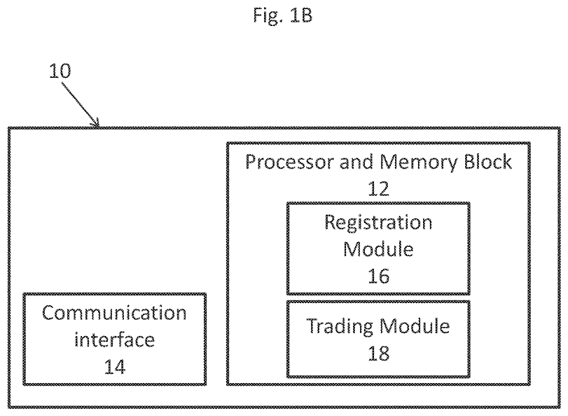

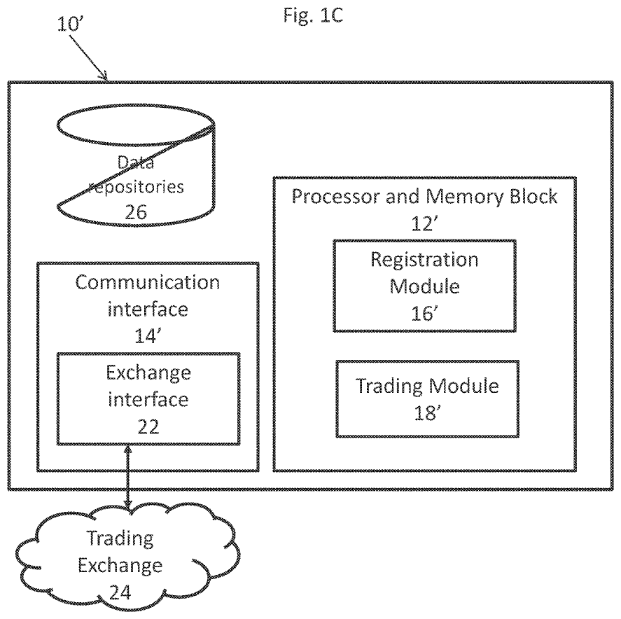

Bearing this in mind, attention is drawn to FIG. 1A illustrating an example network environment for facilitating automatic trading of financial instruments including a plurality of interconnected computers (10-1)-(10-n), connected via computer network (11), in which computers (10-1)-(10-n) are configured in accordance with the presently disclosed subject matter to facilitate automatic trading of financial instruments. At least some of computers (10-1)-(10-n) may be operated by traders in a trading network. These computers can be configured to obtain trading instructions from a trader via a trading interface. Such trading instructions can include, e.g. trade orders (e.g. buy orders, sell orders. etc.). As orders are filled, the quantity of type of assets (i.e. financial instruments) held by each trader in the trading network is subject to revision. At least some of computers (10-1)-(10-n) communicate these revisions to a plurality of other computers (104)-(10-n) over a distributed consensus network in which each computer has a local copy of a distributed ledger in which is stored the transaction history of each trader. Hereinafter the distributed consensus network and distributed ledgers are collectively referred to as a blockchain. As such, at least sonic of computers (104)-(10-n) may further be configured to communicate with other ones of computers (10-1)-(10-n) using blockchain protocols and to read and write data to the blockchain and/or execute smart contracts associated with the blockchain and/or perform other blockchain-related functions.

Referring now to FIG. 1B, there is illustrated an example computer (10) configured to facilitate automatic trading of financial instruments. In certain embodiments, computer (10) can include a processor and memory block (12) configured to perform one or more sequences of operations for facilitating automatic trading of financial instruments, and a communication interface (14) configured to facilitate communication with other computers for the purpose of facilitating trading of financial instruments between traders in the trading network.

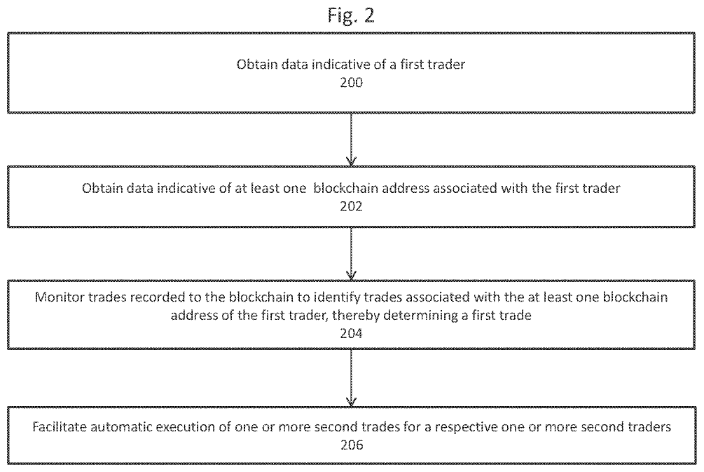

As will be further detailed with reference to FIGS. 2-8, the processor and memory block (hereinafter “processor”) (12) can be configured to execute several functional modules in accordance with computer-readable instructions implemented on a non-transitory computer- readable storage medium. Such functional modules are referred to hereinafter as comprised in the processor. In certain embodiments, the processor can comprise a registration module (16) configured to register traders for automatic trading, and a trading module (18) configured to facilitate the automatic execution of trades.

In certain embodiments, the network environment illustrated in FIG. 1A may be configured to facilitate decentralized trading of financial instruments between traders using blockchain protocols and smart contracts. In this embodiment, trades are executed by the computers (or some of them) themselves in decentralized manner, i.e. without using a third party intermediary or clearing house, e.g. by using blockchain protocols to record trades to the blockchain. By way of non-limiting example, suppose Trader A wishes to buy 30 shares of Apple while Trader B owns 30 shares of Apple and wishes to sell them. In the blockchain, Trader B's shares of Apple may be represented using an arbitrary but predetermined cryptocurrency. For the purposes of this example we will call this cryptocurrency “APLtokens”. Using blockchain protocols and smart contracts, the sale of 30 shares of Apple from B to A can be performed without a trusted intermediary by Trader B transferring 30 APLtokens to Trader A as follows: Trader A transfers (via programmable instructions executed on a computer (10)), the required amount of cryptocurrency (e.g. Ether, Bitcoin, etc., each of which has a given value in fiat currency at any given time) to a smart contract associated with the blockchain. Trader B transfers (via programmable instructions executed on a computer (10)), 30 API-tokens to the smart contract. Once the receipt of the respective cryptocurrencies from Traders A and B are confirmed by the blockchain, the smart contract credits Trader B's blockchain address (or blockchain “wallet”) with the type and amount of cryptocurrency received from Trader A (possibly after deducting a small amount to account for costs associated with the transfer such as trading fees/commissions and/or blockchain “gas”) and credits Trader A's wallet with APLtokens (possibly after deduction for transactions costs). See, for example, United States Patent Publication US 2015/0332395.

In certain other embodiments, the network environment illustrated in FIG. 1A may be configured to facilitate centralized trading of financial instruments between traders. In this embodiment, computers (10-1)-(10-n) (or some of them) diarize, i.e. record, trades to the blockchain using blockchain protocols but in fact the trades are actually executed in centralized manner by a specially designated computer configured to act as a central authority or clearing house, or alternatively to interface with a third party central authority or clearing house. In this embodiment, one of computers (10-1)-(10-n), or a group of computers (10-1)-(10-n) collectively having processing resources that can cooperatively and/or independently process data) can be configured as a trading platform (10′) which performs specialized functions for executing trades on a centralized trading exchange.

FIG. 1C illustrates an example functional diagram of a trading platform (10′) configured to facilitate copy trading of financial instruments using blockchain protocols according to certain examples. In certain embodiments, trading platform (10′) can include a processor and memory block (12′) configured to perform one or more sequences of operations for facilitating automatic trading of financial instruments, and a communication interface (14′) configured to facilitate communication with other computers for the purpose of facilitating trading of financial instruments between traders in the trading network, e.g. receiving trade orders, sending trade confirmations, sending/receiving blockchain updates, etc.

In certain embodiments, the communication interface (14′) of trading platform (10′) can in some embodiments include an exchange interface (22) configured to facilitate communications between the trading platform (10′) and a trading exchange (24) (e.g. NASDAQ, etc.). Such communications can include, e.g. executing trades, receiving trade confirmations, etc.

In certain embodiments, trading platform (10′) can further include data repositories (26) configured to store data related to the performance of a trading platform, including e.g. balance-related data (e.g. balances of cryptocurrency and/or fiat currency of traders) and/or trade-related data (e.g. details of assets and/or instruments held by traders). It should be appreciated that the reference to data repositories is non-limiting and can include a single data repository and/or multiple data repositories including distributed and/or decentralized data repositories. It should be appreciated that the data repositories can physically reside on the trading platform or they can physically reside external to the trading platform

For purposes of illustration, the following is an example of how trading of financial instruments ma be implemented using blockchain protocols but in a centralized manner using trading platform (10′). Suppose Trader A wishes to buy 30 shares of Apple, and that Trader B owns 30 shares of Apple and wants to sell them. Trader B issues, via a computer, instructions to sell 30 shares of Apple. These instructions are sent through the network to trading platform (10′) which then generates and issues a sell order on trading exchange (24). Trader A transfers (via programmable instructions executed on a computer (10)), the required amount of cryptocurrency (e.g. 10 Ether) to a smart contract associated with the blockchain. The smart contract is then being updated that trader A bought 30 shares of Apple. The trading exchange (24) is also being updated accordingly. Assuming Trader A's buy order and Trader's B sell order “align”, Trader B's shares are exchanged with Trader A's cryptocurrency (or an equivalent amount of fiat currency possibly after deducting transactions costs) The trading platform (10′) communicates a confirmation that the trade took place to the smart contract which then diarizes the trade to the blockchain.

In either embodiment, some or all of computers (10-1)-(10-n) (which can include trading platform (20)) can be configured to facilitate, using one or more smart contracts, the automatic execution of copy trades for traders, as will be detailed below with reference to FIGS. 2-8.

It is noted that the teachings of the presently disclosed subject matter are neither bound by the network environment described with reference to FIG. 1A, nor by the computer described with reference to FIG. 1B or FIG. 1C. Equivalent and/or modified functionality can be consolidated or divided in another manner and can be implemented in any appropriate combination of software with firmware and/or hardware and executed on a suitable device.

Having described a computer for facilitating automatic trading of financial instruments, attention is now drawn to FIG. 2, illustrating a generalized flow chart of an example of a sequence of operations that may be carried out for facilitating automatic trading of financial instruments in a computerized trading network in which trades are recorded to a blockchain data structure, and in which each trader is associated with at least one blockchain address, in accordance with certain embodiments of the presently disclosed subject matter.

In certain embodiments, the sequence of operations can be performed by the trading platform (10′). In other embodiments, the sequence of operations can be performed by any computer (10) in the network.

Referring now to FIG. 2, according to some examples of the presently disclosed subject matter, processor (12) can be configured to obtain (200), e.g. from the memory, data indicative of a first trader. Such data can include, e.g. a username or other credentials that can be used to uniquely identify the first trader. The data can be received from a second trader desirous of copying the first trader, and stored in the memory. For example, the data can be received from the second trader during a registration phase in which the second trader registers to copy some or all trades of the first trader, as will be detailed below with reference to FIG. 8, illustrating a generalized flow-chart of registering a second trader in accordance with certain embodiments of the presently disclosed subject matter

During such registration phase, the second trader may input to the computer data identifying a first trader whom the second trader is desirous of copying (e.g. using the first trader's username or other identifying data) and in some embodiments one or more predefined copy criteria which dictate which trades of the first trader are copied for the second trader. The criteria can include such things as a description of a financial instrument (since the second trader may only want to copy trades in certain instruments (e.g. oil) or type of instrument (e.g. stocks), position type (e.g. long), investment amount (this specifies how much money should be invested by the second trader in the copy trade), leverage amount, etc. Further examples of criteria that may be input by the second trader in accordance with certain embodiments are detailed in WO 2017/149254, which is incorporated by reference herein. Once the input is received from the second trader during the registration phase, an association between the second trader and the first trader is created and registered, e.g. in a database.

Having obtained the data indicative of the first trader, in certain embodiments, processor (12) can be configured (e.g. using trading module (18)) to obtain (202) (e.g. from the memory) data indicative of at least one blockchain address associated with the first trader. For example, the processor can query a database in which the data indicative of a first trader (e.g. username, etc.) is associated with one or more blockchain addresses. It will be appreciated to those skilled in the art that parties to blockchain transactions are anonymous, and traceable only to a given blockchain address. As such, the processor should have access to blockchain addresses associated with traders in order to associate trades recorded to the blockchain as pertaining to particular traders.

Having obtained at least one blockchain address of the first trader, in certain embodiments, processor (12) can be configured (e.g. using trading module (18)) to monitor (204) the trades recorded to the blockchain data structure to identify trades associated with the at least one blockchain address of the first trader, thereby determining when a trade has been executed for the first trader. Each such identified trade is referred to herein as a “first trade”.

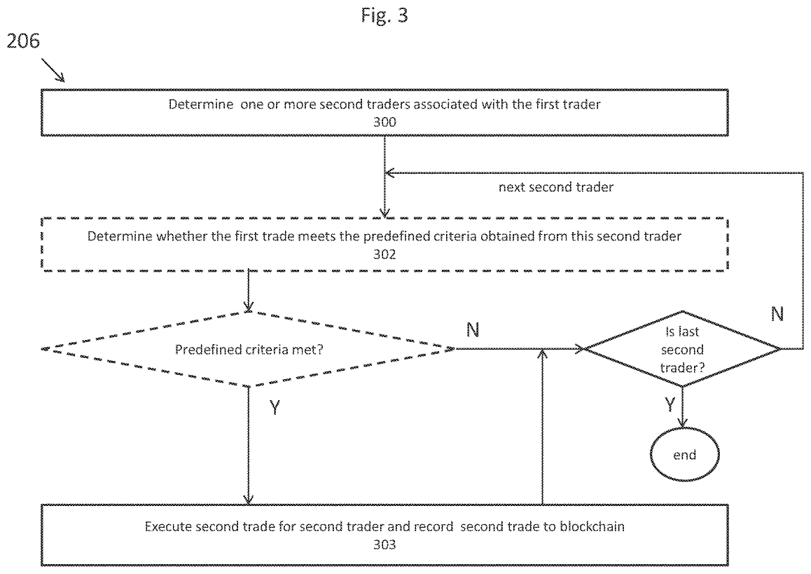

Upon identifying a first trade, processor (12) can be configured (e.g. using trading module (18)) to facilitate (206), using a smart contract associated with the blockchain, the automatic execution of one or more second trades on behalf of one or more respective second traders, as will be further detailed below with reference to FIG. 3, illustrating a generalized flow-chart of facilitating automatic execution of a second trade in accordance with certain embodiments of the presently disclosed subject matter

According to some examples, as illustrated in FIG. 3, facilitating (206) automatic execution of one or more second trades can include all or some of the following steps:
(i) determining one or more second traders that are associated with the first trader (300). If there are no associated second traders, nothing further is done;
(ii) optionally, in some embodiments, determining, for each of one or more associated second traders, whether the first trade meets predefined criteria obtained from the respective second trader (302). In some embodiments this step can be omitted, e.g. in implementations where traders either copy all of the trades of a first trader, or none of them; and
(iii) for each associated second trader (or only for those in respect of whom the predefined criteria are met in step (302)), executing a second trade for the second trader and recording the second trade to the blockchain in association with the blockchain address of the second trader (303).

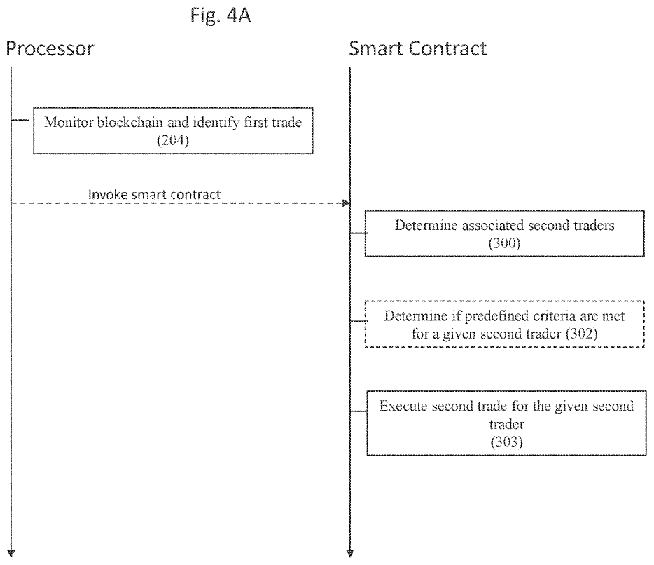

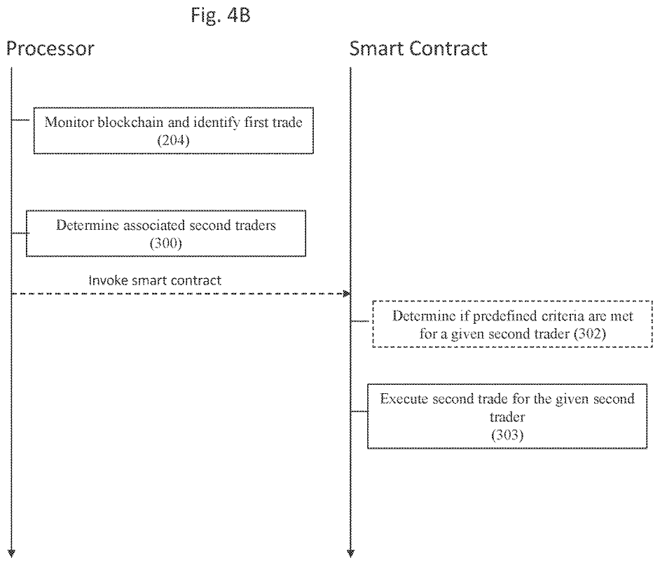

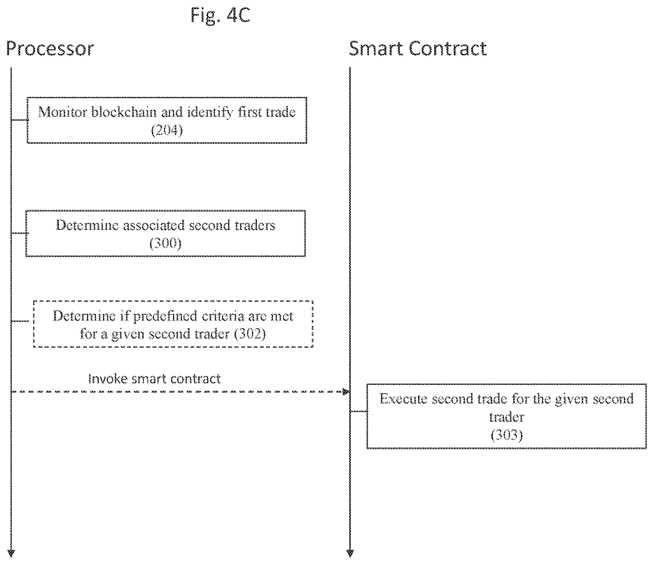

According to sonic examples, the above steps (i)-(iii) can be divided between the processor and the smart contract in a number of different ways, as will be detailed below with reference to FIGS. 4A-4C, illustrating some examples of facilitating automatic execution of a second trade in accordance with certain embodiments of the presently disclosed subject matter.

By way of non-limiting example, as illustrated in FIG. 4A, the processor (12) can, upon identifying a first trade, invoke the smart contract to (i) determine which, if any, second traders are associated with the first trader, (ii) in some embodiments determine, for each of the one or more associated second traders, whether the first trade meets the predefined criteria obtained from the respective second trader, and if met to (iii) automatically execute a second trade for the respective second trader and record the second trade to the blockchain. According to this example, “facilitating” execution of a second trade includes invoking the smart contract to perform steps (i)-(iii).

Alternatively, by way of additional non-limiting example, as illustrated in FIG. 4B, the processor (12) can (i) determine which, if any, second traders are associated with the first trader, and subsequently invoke the smart contract to (ii) in some embodiments determine, for each of the one or more associated second traders, whether the first trade meets the predefined criteria obtained from the respective second trader, and if met to (iii) automatically execute a second trade for the respective second trader and record the second trade to the blockchain. According to this example, “facilitating” execution of a second trade includes performing step (i) and subsequently invoking the smart contract to perform steps (ii)-(iii).

Alternatively, by way of additional non-limiting example, as illustrated in FIG. 4C, the processor can, upon determining a first trade, (i) determine which, if any, second traders are associated with the first trader; (ii) in some embodiments determine, for each of the one or more associated second traders, whether the first trade meets the predefined criteria obtained from the respective second trader; and, for each second trader in respect of whom the predefined criteria are met, the system/processor can invoke the smart contract to (iii) automatically execute a second trade for the respective second trader and record the second trade to the blockchain. According to this example, “facilitating” execution of a second trade includes performing step (i) and, if applicable step (ii), and subsequently invoking the smart contract to perform step (iii).

It should be appreciated by those skilled in the art that in certain embodiments, a second trader may also be copied by another trader (i.e. a “third trader”). For example. Trader B may register to copy trades of Trader A, while Trader C (the “third” trader) registers to copy trades of Trader B (with or without knowledge that Trader B is copying Trading A). In this example, as between Trader A and Trader B, the former is a first trader and the latter is second trader. However as between Trader B and Trader C. Trader B is a first trader. Thus in this example Trader B is concurrently a first trader with respect to Trader C and a second trader with respect to Trader A.

As the above example demonstrates, in certain embodiments, one or more of the second traders may be associated with a third trader, in which case upon execution of a second trade for the second trader, steps (300)-(303) may be repeated with the second trader now being the first trader and the one or more third traders now being the one or more second traders. It should be appreciated that a third trader may be associated with a fourth trader that copies the third trader, etc. In fact, execution of a given first trade can potentially trigger multiple levels of copy trading.

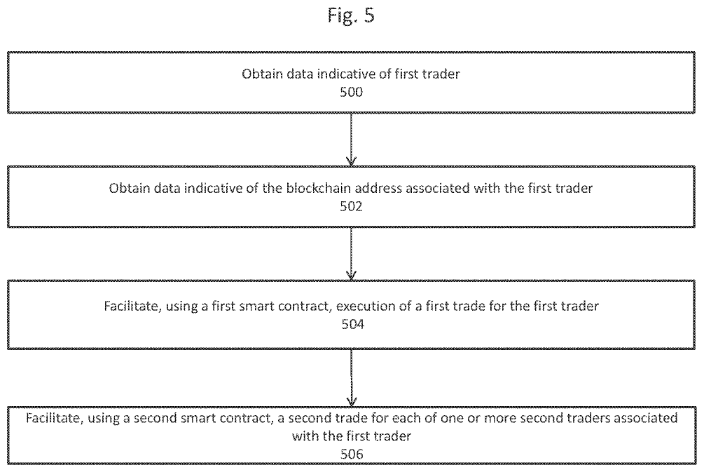

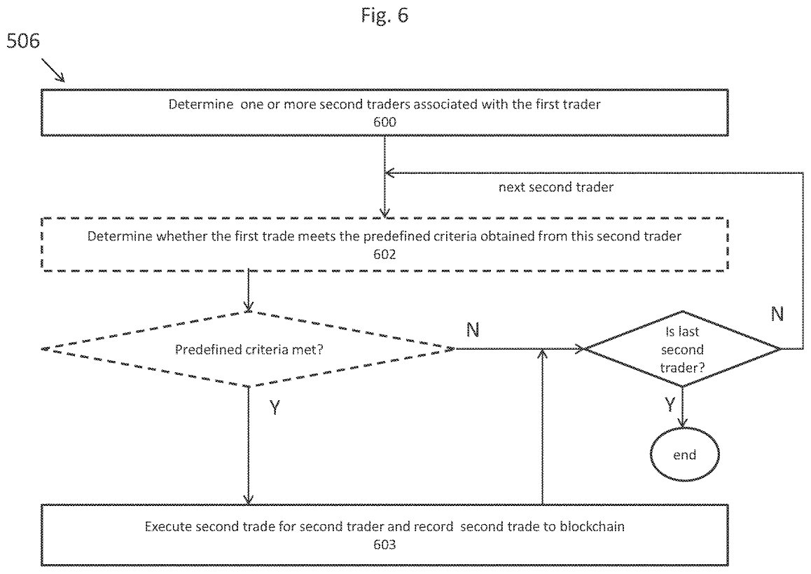

In certain other embodiments, a smart contract can be invoked (e.g. by a processor) to execute a first trade for the first trader. In this embodiment, a first smart contract can execute the first trade and subsequently invoke a second smart contract to execute one or more second trades, as will be detailed below with reference to FIGS. 5-6.

FIG. 5 illustrates a generalized flow chart of an example of a sequence of operations that may be carried out for facilitating automatic trading of financial instruments in a computerized trading network in which trades are recorded to a blockchain data structure and in which each trader is associated with at least one blockchain address, in accordance with certain other embodiments of the presently disclosed subject matter.

Referring now to FIG. 5, according to some examples of the presently disclosed subject matter, processor (12) can be configured (e.g. using trading module (18)) to obtain (500), e.g. from the memory, data indicative of a first trader. The data indicative of a first trader as detailed above with reference to FIG. 2 is also applicable here mutatis mutandis.

In certain embodiments, processor (12) can be configured (e.g. using trading module (18)) to obtain (502) ((e.g. from the memory) data indicative of one or more blockchain addresses associated with the first trader. The data indicative of one or more blockchain addresses associated with the first trader as detailed above with reference to FIG. 2 is also applicable here mutatis mutandis.

In certain embodiments, processor (12) can be configured (e.g. using trading module (18)) to facilitate (504) execution of a first trade for the first trader, where “facilitating” includes using a first smart contract to execute the first trade and to record the first trade to the blockchain in association with the blockchain address of the first trader. By way of non-limiting example, this can be achieved as follows: Trader A wants to buy shares of Apple. Trader A transfers to the first smart contract an amount of currency (e.g. cryptocurrency) of a first type (e.g. Ether, Bitcoin, etc.). The first contract executes code that causes Trader A to buy Apple shares, and then transfers to Trader A an amount of an arbitrary but predetermined currency (e.g. cryptocurrency) of a second type that “represents” those Apple shares just bought (e.g. APLtokens, as in the examples above). In this example, ownership of the virtual currency APLtokens signifies the real-world ownership Apple shares.

Having executed a first trade for the first trader, in certain embodiments, processor (12) can be configured (e.g. using trading module (18)) to facilitate (506), using a second smart contract, automatic execution of one or more second trades for a respective one or more second traders associated with the first trader, and to record the one or more second trades to the blockchain in association with the respective blockchain addresses of the respective second traders.

According to some examples, as illustrated in FIG. 6, “facilitating automatic execution of one or more second trades” can include some or all of the following steps:
(i) determining one or more second traders that are associated with the first trader (600), If there are no associated second traders, nothing further is done;
(ii) optionally, in some embodiments, determining, for each of one or more associated second traders, whether the first trade meets predefined criteria obtained from the respective second trader (602). In some embodiments this step can be omitted, e.g. in implementations where traders either copy all of the trades of a first trader, or none of them; and
(iii) for each associated second trader (or only for those in respect of whom the predefined criteria are met in step (602)), executing a second trade for the second trader and recording the second trade to the blockchain in association with the blockchain address of the second trader (603).

According to some examples, the above steps (i)-(iii) can be divided between the first smart contract and the second smart contract in a number of different ways.

By way of non-limiting example, the first smart contract can execute the first trade for the first trader, and then invoke the second smart contract to determine which, if any, second traders are associated with the second trader, and to execute the second trade for the given second trader (or in some embodiments only upon determining that predefined criteria obtained from the second trader are met) and to record the second trade to the blockchain in association with a blockchain address of the given second trader. The division of operations in this example is similar to that shown in FIG. 4A, but with the left-hand operations being performed by a smart contract, and with substituting the step “monitor blockchain and identify first trade (204)” with the step of “executing a first trade (504)”.

Alternatively, according to a further non-limiting example, the first smart contract can execute the first trade for the first trader, and determine which, if any, second traders are associated with the second trader. The first contract can then invoke the second smart contract to execute the second trade for the given second trader (in some embodiments only upon determining that predefined criteria obtained from the second trader are met), and to record the second trade to the blockchain in association with a blockchain address of the given second trader. The division of operations in this example is similar to that shown in FIG. 4B, but with the left-hand operations being performed by a smart contract, and with substituting the step “monitor blockchain and identify first trade (204)” with the step of “executing a first trade (504)”.

Alternatively, according to a further non-limiting example, the first smart contract can execute the first trade for the first trader, determine which, if any, second traders are associated with the second trader, (and in some embodiments determine whether the predefined criteria obtained from a given second trader is met), and invoke the second smart contract to execute the second trade for the given second trader (in some embodiments only if the obtained criteria are met) and to record the second trade to the blockchain in association with a blockchain address of the given second trader. The division of operations in this example is similar to that shown in FIG. 4C, but with the left-hand operations being performed by a smart contract, and with substituting the step “monitor blockchain and identify first trade (204)” with the step of “executing a first trade (504)”.

Alternatively, according to a further non-limiting example, the first smart contract and the second smart contract can be the same smart contract, i.e. a single smart contract can perform all of the operations. Thus in other words, the first smart contract can i) execute the first trade for the first trader, ii) determine which, if any, second traders are associated with the second trader, iii) execute the second trade for the given second trader (or in some embodiments only upon determining that predefined criteria obtained from the second trader are met) and record the second trade to the blockchain in association with a blockchain address of the given second trader.

As detailed above, in certain embodiments a trader who is desirous of being copied by other traders may first be required to register as a first trader. In certain embodiments, first traders may be required to provide value (i.e. some form of payment) in order to register as a first trader. In some embodiments, the value that the first trader must provide can be in the form of cryptocurrency. In certain embodiments, a first trader may be able to receive value (i.e. some form of payment) when the first trader's trades are copied, In some embodiments, the value received can be in the form of cryptocurrency. In some embodiments, the value can be in the form of an incentive, such as, e.g., a cash payment, or lower fees/commissions for trades, rank increase, etc.). In certain embodiments, a smart contract can be used to register a first trader and to facilitate the exchanges of value detailed above.

Referring now to FIG. 7, there is illustrated a generalized flow chart of an example of a series of operations that may be performed by the smart contract to register a first trader. At block (700) the smart contract receives a request to register “Trader A” as a first trader. For example, a processor (12), e.g. using registration module (16), may invoke the smart contract. In certain embodiments the request can be initiated by Trader A. For example, Trader A can interact with a specially configured user interface on a computer (10) in order to initiate the request. In certain other embodiments, the trading platform (10′) can initiate the request to the smart contract to register a first trader. In certain embodiments the request can include permission to debit Trader A's wallet balance a predetermined amount of currency, such as cryptocurrency (e.g. Ether, Bitcoin, etc.) as payment for registering as a first trader.

At block (702), the smart contract checks Trader A's wallet balance to verify that Trader A has a sufficient amount of currency in order to register as a first trader. In some embodiments, the smart contract may check and confirm other required parameters for registering as a first trader, e.g. that a risk level associated with the trader is within a predetermined threshold risk level, etc.). Upon successful completion of the necessary verifications, at block (704), the smart contract transfers the amount of currency from Trader A's wallet to the smart contract. At block (706), the smart contract adds Trader A (e.g. using Trader A's blockchain address(es)) to the list of registered first traders.

As detailed above, in certain embodiments a trader who is desirous of copying another trader may be required to first register as a second trader. In certain embodiments, second traders may be required to provide value in order to register as a second trader, e.g. some form of payment (which can include, e.g. payment in cryptocurrency). In certain embodiments, all or part of the value received from a second trader may be transferred to a first trader upon execution of a copy trade for the second trader. In certain embodiments, registration of a second trader may be performed by a smart contract (which can be the same contract or a different smart contract that performs the copy trades and/or registers the first traders).

Referring now to FIG. 8, there is illustrated a generalized flow chart of an example of a series of operations that may be performed by a smart contract to register a second trader. At block (800) the smart contract receives a request to register “Trader B” as a second trader which is desirous of copying Trader A, and in some embodiments further receives criteria for copying trades of Trader A (e.g. which trades to copy, the desired amount of funds to be invested, etc. as detailed above). In certain embodiments, the request can be initiated by Trader B. For example, Trader B can interact with a specially configured user interface on a computer (10) in order to initiate the request, after which processor (12), e.g. using registration module (16), may invoke the smart contract. In certain embodiments, the user interface can provide Trader B with a list of registered first traders to choose from. In certain embodiments, the request can include permission to debit Trader B's wallet balance a predetermined quantity of cryptocurrency as payment for registering as a second trader and/or for funding the copy trade(s).

At block (802), the smart contract can check Trader B's wallet balance to verify that Trader B has a sufficient amount of currency to perform the request. After verifying that Trader B has the required amount of currency, at block (804), the smart contract can transfer the amount of currency from Trader B's wallet to the smart contract. At block (806) the smart contract adds Trader B (e.g. using Trader B's blockchain address) to the list of registered second traders and creates and stores, e.g. in a database, an association between the first and second trader. In some embodiments, criteria for copying trades of the first trader which may be provided by the second trader is also stored, e.g. in a database.

It should be noted that in some embodiments computers (10-1)-(10-n) can include computers of different types (i.e. serve different purposes), such as computers of a first type that may operate as nodes of the blockchain e.g. for processing blockchain transactions, which in some case can operate autonomously) and computers of a second type that may be operated by traders and configured to facilitate user interaction with the system described herein for facilitating automatic trading of financial instruments.

It is noted that the teachings of the presently disclosed subject matter are not bound by the flow charts illustrated in FIGS. 2-8, the illustrated operations can occur out of the illustrated order. It is also noted that whilst the flow chart is described with reference to elements of computer (10), this is by no means binding, and the operations can be performed by elements other than those described herein.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

It will also be understood that the system according to the invention may be, at least partly, implemented on a suitably programmed computer. Likewise, the invention contemplates a computer program being readable by a computer for executing the method of the invention. The invention further contemplates a non-transitory computer-readable memory tangibly embodying a program of instructions executable by the computer for executing the method of the invention.

Those skilled in the art will readily appreciate that various modifications and changes can be applied to the embodiments of the invention as hereinbefore described without departing from its scope, defined in and by the appended claims.

1. A computer-implemented method of facilitating automatic trading of financial instruments in a computerized trading network in which trades are recorded to a blockchain data structure and in which each trader is associated with one or more blockchain addresses, the method comprising, by a processor operatively coupled to a memory:
i) obtaining from the memory data indicative of a first trader;
ii) obtaining data indicative of at least one blockchain address associated with the first trader;
iii) monitoring the trades recorded to the blockchain data structure to identify trades associated with the at least one blockchain address of the first trader, thereby determining when a first trade has been executed for the first trader; and
iv) upon determining that a first trade has been executed for the first trader, facilitating, using a smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

2. The method of claim 1 wherein the automatic execution of a respective second trade is performed only upon the first trade meeting predefined criteria obtained from the respective second trader, and wherein said facilitating further includes facilitating, using the smart contract, the determination, for each second trader associated with the first trader, whether the first trade meets the predefined criteria obtained from the respective second trader.

3. The method of claim 1 wherein one or more of the second traders are each associated with one or more third traders, and wherein upon facilitating execution of a second trade for a second trader, steps i) to iv) are repeated with the second trader now being the first trader and the one or more third traders now being the one or more second traders.

4. The method of claim 1 further comprising using the smart contract to register the one or more second traders to copy trades of the first trader.

5. The method of claim 4 wherein the smart contract registers a given second trader only upon obtaining value from the given second trader.

6. The method of claim 1 further comprising using the smart contract to provide value to the first trader upon the execution of one or more second trades.

7. The method of claim 5 wherein said value is in the form of cryptocurrency.

8. A computer configured for facilitating automatic trading of financial instruments in a computerized trading network in which trades are recorded to a blockchain data structure and in which each trader is associated with one or more blockchain addresses, comprising:
a memory; and
a processor operatively coupled to the memory and configured to:
i) obtain from the memory data indicative of a first trader;
ii) obtain data indicative of at least one blockchain address associated with the first trader;
iii) monitor the trades recorded to the blockchain data structure to identify trades associated with the at least one blockchain address of the first trader, thereby determining when a first trade has been executed for the first trader; and
iv) upon determining that a first trade has been executed for the first trader, facilitate, using a smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

9. The computer of claim 8 wherein the automatic execution of a respective second trade is performed only upon the first trade meeting predefined criteria obtained from the respective second trader, and wherein said facilitate further includes to facilitate the determination, for each second trader associated with the first trader, whether the first trade meets the predefined criteria obtained from the respective second trader.

10. The computer of claim 8 wherein one or more of the second traders are each associated with one or more third traders, and wherein upon the execution of a second trade for a second trader, said processor is configured to repeat steps i) to iv) with the second trader now being the first trader and the one or more third traders now being the one or more second traders.

11. The computer of claim 8 wherein said processor is further configured to use the smart contract to register the one or more second traders to copy trades of the first trader.

12. The computer of claim 11 wherein the smart contract registers a given second trader only upon obtaining value from the given second trader.

13. The computer of claim 8 wherein said processor is further configured to use the smart contract to provide value to the first trader upon the execution of a second trade.

14. The computer of claim 12 wherein said value is in the form of cryptocurrency.

15. A computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising:
i) obtaining from the memory data indicative of a first trader;
ii) obtaining data indicative of at least one blockchain address associated with the first trader;
iii) monitoring the trades recorded to the blockchain data structure to identify trades associated with the at least one blockchain address of the first trader, thereby determining when a first trade has been executed for the first trader; and
iv) upon determining that a first trade has been executed for the first trader, facilitating, using a smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

16. The computer program product of claim 15 wherein the automatic execution of a respective second trade is performed only upon the first trade meeting predefined criteria obtained from the respective second trader, and wherein said facilitating further includes facilitating, using the smart contract, the determination, for each second trader associated with the first trader, whether the first trade meets the predefined criteria obtained from the respective second trader.

17. The computer program product of claim 15 wherein one or more of the second traders are each associated with one or more third traders, wherein upon facilitating execution of a second trade for a second trader, steps i) to iv) are repeated with the second trader now being the first trader and the one or more third traders now being the one or more second traders.

18. The computer program product of claim 15, wherein the method further comprises using the smart contract to register the one or more second traders to copy trades of the first trader.

19. The computer program product of claim 18 wherein the smart contract registers a given second trader only upon obtaining value from the given second trader.

20. The computer program product of claim 15 wherein the method further comprises using the smart contract to provide value to the first trader upon the execution of one or more second trades.

21. The computer program product of claim 19 wherein the value is in the form of cryptocurrency.

22. A computer-implemented method of facilitating automatic trading of financial instruments in a computerized trading network in which trades are recorded to a blockchain data structure and in which each trader is associated with one or more blockchain addresses, the method comprising, by a processor operatively coupled to a memory:
i) obtaining from the memory data indicative of a first trader;
ii) obtaining data indicative of at least one blockchain address associated with the first trader;
iii) monitoring the trades recorded to the blockchain data structure to identify trades associated with the at least one blockchain address of the first trader, thereby determining when a first trade has been executed for the first trader;
iv) determining one or more second traders associated with said first trader; and
v) facilitating, using a smart contract associated with the blockchain data structure, the automatic execution of a respective second trade for each of the one or more associated second traders and recording each respective second trade to the blockchain data structure in association with a blockchain address of the respective second trader.

23. The method of claim 22 wherein the automatic execution of a respective second trade is performed only upon the first trade meeting predefined criteria obtained from the respective second trader, and wherein said facilitating further includes facilitating the determination, for each second trader associated with the first trader, whether the first trade meets the predefined criteria obtained from the respective second trader.

24. The method of claim 22 wherein one or more of the second traders are each associated with one or more third traders, and wherein upon facilitating execution of a second trade for a second trader, steps i) to v) are repeated with the second trader now being the first trader and the one or more third traders now being the one or more second traders.

25. The method of claim 22 further comprising using the smart contract to register the one or more second traders to copy trades of the first trader.

26. The method of claim 25 wherein the smart contract registers a given second trader only upon obtaining value from the given second trader.

27. The method of claim 22 further comprising using the smart contract to provide value to the first trader upon the execution of one or more second trades.

28. The method of claim 26 wherein said value is in the form of cryptocurrency.

29. A computer configured for facilitating automatic trading of financial instruments in a computerized trading network in which trades are recorded to a blockchain data structure and in which each trader is associated with one or more blockchain addresses, comprising:
a memory; and
a processor operatively coupled to the memory and configured to:
i) obtain from the memory data indicative of a first trader;
ii) obtain data indicative of at least one blockchain address associated with the first trader;
iii) monitor the trades recorded to the blockchain data structure to identify trades associated with the at least one blockchain address of the first trader, thereby determining when a first trade has been executed for the first trader;
iv) determine one or more second traders associated with said first trader; and
v) facilitate, using a smart contract associated with the blockchain data structure, the automatic execution of a respective second trade for each of the one or more associated second traders and recording of each respective second trade to the blockchain data structure in association with a blockchain address of the respective second trader.

30. The computer of claim 29 wherein the automatic execution of a respective second trade is performed only upon the first trade meeting predefined criteria obtained from the respective second trader, and wherein said facilitating further includes facilitating the determination, for each second trader associated with the first trader, whether the first trade meets the predefined criteria obtained from the respective second trader.

31. The computer of claim 29 wherein one or more of the second traders are each associated with one or more third traders, and wherein upon facilitating execution of a second trade for a second trader, steps i) to v) are repeated with the second trader now being the first trader and the one or more third traders now being the one or more second traders.

32. The computer of claim 29 wherein said processor is further configured to use the smart contract to register the one or more second traders to copy trades of the first trader.

33. The computer of claim 32 wherein the smart contract registers a given second trader only upon obtaining value from the given second trader.

34. The computer of claim 29 wherein said processor is further configured to use the smart contract to provide value to the first trader upon the execution of one or more second trades

35. The computer of claim 33 wherein said value is in the form of cryptocurrency.

36. A computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising, the method comprising:
i) obtaining from the memory data indicative of a first trader;
ii) obtaining data indicative of at least one blockchain address associated with the first trader;
iii) monitoring the trades recorded to the blockchain data structure to identify trades associated with the at least one blockchain address of the first trader, thereby determining when a first trade has been executed for the first trader;
iv) determining one or more second traders associated with said first trader; and
v) facilitating, using a smart contract associated with the blockchain data structure, the automatic execution of a respective second trade for each of the one or more associated second traders and recording each respective second trade to the blockchain data structure in association with a blockchain address of the respective second trader.

37. The computer program product of claim 36 wherein the automatic execution of a respective second trade is performed only upon the first trade meeting predefined criteria obtained from the respective second trader, and wherein said facilitating further includes facilitating the determination, for each second trader associated with the first trader, whether the first trade meets the predefined criteria obtained from the respective second trader.

38. The computer program product of claim 36 wherein one or more of the second traders are each associated with one or more third traders, and wherein upon facilitating execution of a second trade for a second trader, steps i) to v) are repeated with the second trader now being the first trader and the one or more third traders now being the one or more second traders.

39. The computer program product of claim 36, the method further comprising using the smart contract to register the one or more second traders to copy trades of the first trader.

40. The computer program product of claim 39 wherein the smart contract registers a given second trader only upon obtaining value from the given second trader.

41. The computer program product of claim 36, the method further comprising using the smart contract to provide value to the first trader upon the execution of one or more second trades

42. The computer program product of claim 40 wherein said value is in the form of cryptocurrency.

43. A computer-implemented method of facilitating automatic trading of financial instruments in a computerized trading network in which trades are recorded to a blockchain data structure and in which each trader is associated with one or more blockchain addresses, the method comprising, by a processor operatively coupled to a memory:
i) obtaining from the memory data indicative of a first trader;
ii) obtaining data indicative of at least one blockchain address associated with the first trader;
iii) monitoring the trades recorded to the blockchain data structure to identify trades associated with the at least one blockchain address of the first trader, thereby determining when a first trade has been executed for the first trader;
iv) determining one or more second traders associated with said first trader; and
v) facilitating automatic execution of a respective second trade for each said second trader, wherein said facilitating includes using a smart contract associated with the blockchain data structure for automatic execution of a respective second trade for the respective second trader and recording the second trade to the blockchain data structure in association with a blockchain address of the respective second trader.

44. The method of claim 43 further comprising, by the processor: determining, for each said second trader, whether the first trade meets respective predefined criteria obtained from the respective second trader, wherein said facilitating is performed only in respect of second traders in respect of whom said criteria are met.

45. The method of claim 43 wherein one or more of the second traders are each associated with one or more third traders, and wherein upon facilitating execution of a second trade for a second trader, steps i) to v) are repeated with the second trader now being the first trader and the one or more third traders now being the one or more second traders.

46. The method of claim 43 further comprising using the smart contract to register the one or more second traders to copy trades of the first trader.

47. The method of claim 46 wherein the smart contract registers a given second trader only upon obtaining value from the given second trader.

48. The method of claim 43 further comprising using the smart contract to provide value to the first trader upon the execution of one or more second trades.

49. The method of claim 47 wherein said value is in the form of cryptocurrency.

50. A computer configured for facilitating automatic trading of financial instruments in a computerized trading network in which trades are recorded to a blockchain data structure and in which each trader is associated with one or more blockchain addresses, comprising:
a memory; and
a processor operatively coupled to the memory and configured to:
i) obtain from the memory data indicative of a first trader;
ii) obtain data indicative of at least one blockchain address associated with the first trader;
iii) monitor the trades recorded to the blockchain data structure to identify trades associated with the at least one blockchain address of the first trader, thereby determining when a first trade has been executed for the first trader;
iv) determine one or more second traders associated with said first trader; and
v) facilitate automatic execution of a respective second trade for each said second trader, wherein said facilitate includes using a smart contract associated with the blockchain data structure for automatic execution of a respective second trade for the respective second trader and recording the second trade to the blockchain data structure in association with a blockchain address of the respective second trader.

51. The computer of claim 50 wherein said processor is further configured to: determine, for each said second trader, whether the first trade meets respective predefined criteria obtained from the respective second trader, wherein said facilitate is performed only in respect of second traders in respect of whom said criteria are met.

52. The computer of claim 50 wherein one or more of the second traders are each associated with one or more third traders, and wherein upon facilitating execution of a second trade for a second trader, steps i) to v) are repeated with the second trader now being the first trader and the one or more third traders now being the one or more second traders.

53. The computer of claim 50 wherein said processor is further configured to use the smart contract to register the one or more second traders to copy trades of the first trader.

54. The computer of claim 53 wherein the smart contract registers a given second trader only upon obtaining value from the given second trader.

55. The computer of claim 50 wherein said processor is further configured to use the smart contract to provide value to the first trader upon the execution of one or more second trades

56. The computer of claim 54 wherein said value is in the form of cryptocurrency.

57. A computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising:
i) obtaining from the memory data indicative of a first trader;
ii) obtaining data indicative of at least one blockchain address associated with the first trader;
iii) monitoring the trades recorded to the blockchain data structure to identify trades associated with the at least one blockchain address of the first trader, thereby determining when a first trade has been executed for the first trader;
iv) determining one or more second traders associated with said first trader; and
v) facilitating automatic execution of a respective second trade, wherein said facilitating includes using a smart contract associated with the blockchain data structure for automatic execution of a respective second trade for the respective second trader and recording the second trade to the blockchain data structure in association with a blockchain address of the respective second trader.

58. The computer program product of claim 57 wherein the method further comprises, determining, for each said second trader, whether the first trade meets respective predefined criteria obtained from the respective second trader, wherein said facilitating is performed only in respect of second traders in respect of whom said criteria are met.

59. The computer program product of claim 57 wherein one or more of the second traders are each associated with one or more third traders, and wherein upon facilitating execution of a second trade for a second trader, steps i) to v) are repeated with the second trader now being the first trader and the one or more third traders now being the one or more second traders.

60. The computer program product of claim 57, the method further comprising using the smart contract to register the one or more second traders to copy trades of the first trader.

61. The computer program product of claim 60 wherein the smart contract registers a given second trader only upon obtaining value from the given second trader.

62. The computer program product of claim 57, the method further comprising using the smart contract to provide value to the first trader upon the execution of one or more second trades.

63. The computer program product of claim 61 wherein said value is in the form of cryptocurrency.

64. A computer-implemented method of facilitating automatic trading of financial instruments in a computerized trading network in which trades are recorded to a blockchain data structure and in which each trader is associated with one or more blockchain addresses, the method comprising, by a processor operatively coupled to a memory:
i) obtaining from the memory data indicative of a first trader;
ii) obtaining data indicative of at least one blockchain address associated with the first trader;
iii) facilitating execution of a first trade for the first trader, said facilitating including using a first smart contract to record the first trade to the blockchain data structure in association with the at least one blockchain address of the first trader; and
iv) facilitating, using a second smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

65. The method of claim 64 wherein the automatic execution of a respective second trade is performed only upon the first trade meeting predefined criteria obtained from the respective second trader, and wherein in step (iv) said facilitating further includes facilitating, using the second smart contract, the determination, for each second trader associated with the first trader, whether the first trade meets the predefined criteria obtained from the respective second trader.

66. The method of claim 64 wherein one or more of the second traders are each associated with one or more third traders, and wherein upon facilitating execution of a second trade for a second trader, steps i) to iv) are repeated with the second trader now being the first trader and the one or more third traders now being the one or more second traders.

67. The method of claim 64 further comprising using the second smart contract to register the one or more second traders to copy trades of the first trader.

68. The method of claim 67 wherein the second smart contract registers a given second trader only upon obtaining value from the given second trader.

69. The method of claim 64 further comprising using the second smart contract to provide value to the first trader upon the execution of one or more second trades.

70. The method of claim 68 wherein said value is in the form of cryptocurrency.

71. The method of claim 64 wherein the first smart contract and the second smart contract are the same smart contract.

72. A computer configured for facilitating automatic trading of financial instruments in a computerized trading. network in which trades are recorded to a. blockchain data structure and in which each trader is associated with one or more blockchain addresses, comprising:
a memory; and
a processor operatively coupled to the memory and configured to:
i) obtain from the memory data indicative of a first trader;
ii) obtain data indicative of at least one blockchain address associated with the first trader;
iii) facilitate execution of a first trade for the first trader, said facilitate including using a first smart contract to record the first trade to the blockchain data structure in association with the at least one blockchain address of the first trader; and
iv) facilitate, using a second smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

73. The computer of claim 72 wherein the automatic execution of a respective second trade is performed only upon the first trade meeting predefined criteria obtained from the respective second trader, and wherein in step (iv) said facilitate further includes to facilitate the determination, for each second trader associated with the first trader, whether the first trade meets the predefined criteria obtained from the respective second trader.

74. The computer of claim 72 wherein one or more of the second traders are each associated with one or more third traders, and wherein upon the execution of a second trade for a second trader, said processor is configured to repeat steps (i) to (iv) with the second trader now being the first trader and the one or more third traders now being the one or more second traders.

75. The computer of any of claim 72 wherein said processor is further configured to use the second smart contract to register the one or more second traders to copy trades of the first trader.

76. The computer of claim 75 wherein the second smart contract registers a given second trader only upon obtaining value from the given second trader.

77. The computer of claim 72 wherein said processor is further configured to use the second smart contract to provide value to the first trader upon the execution of a second trade.

78. The computer of claim 76 wherein said value is in the form of cryptocurrency.

79. The computer of claim 72 wherein said first smart contract and said second smart contract are the same smart contract.

80. A computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising:
i) obtaining from the memory data indicative of a first trader;
ii) obtaining data indicative of at least one blockchain address associated with the first trader;
iii) facilitating execution of a first trade for the first trader, said facilitating including using a first smart contract to record the first trade to the blockchain data structure in association with the at least one blockchain address of the first trader; and
iv) facilitating, using a second smart contract associated with the blockchain data structure, the determination of one or more second traders which are associated with the first trader and, for each of said second traders, the automatic execution of a respective second trade and the recording of each respective second trade to the blockchain data structure in association with a blockchain address of the respective second trader.

81. The computer program product of claim 80 wherein the automatic execution of a respective second trade is performed only upon the first trade meeting predefined criteria obtained from the respective second trader, and wherein in step (iv) said facilitating further includes facilitating, using the second smart contract, the determination, for each second trader associated with the first trader, whether the first trade meets the predefined criteria obtained from the respective second trader.

82. The computer program product of claim 80 wherein one or more of the second traders are each associated with one or more third traders, wherein upon facilitating execution of a second trade for a second trader, steps i) to iv) are repeated with the second trader now being the first trader and the one or more third traders now being the one or more second traders.

83. The computer program product of claim 80, wherein the method further comprises using the second smart contract to register the one or more second traders to copy trades of the first trader.

84. The computer program product of claim 83 wherein the second smart contract registers a given second trader only upon obtaining value from the given second trader.

85. The computer program product of claim 80 wherein the method further comprises using the second smart contract to provide value to the first trader upon the execution of one or more second trades.

86. The computer program product of claim 84 wherein the value is in the form of cryptocurrency.

87. The computer program product of claim 80 wherein the first smart contract and the second smart contract are the same smart contract.

88. A computer-implemented method of facilitating automatic trading of financial instruments in a computerized trading network in which trades are recorded to a blockchain data structure and in which each trader is associated with one or more blockchain addresses, the method comprising, by a processor operatively coupled to a memory:
i) obtaining from the memory data indicative of a first trader;
ii) obtaining data indicative of at least one blockchain address associated with the first trader;
iii) facilitating execution of a first trade for the first trader, said facilitating including using a first smart contract to record the first trade to the blockchain data structure in association with the blockchain address of the first trader;
iv) facilitating, using the first smart contract, the determination of one or more second traders which are associated with the first trader; and
v) facilitating, using a second smart contract associated with the blockchain data structure, for each of said second traders, the automatic execution of a respective second trade and the recording of each respective second trade to the blockchain data structure in association with a blockchain address of the respective second trader.

89. The method of claim 88 wherein the automatic execution of a respective second trade is performed only upon the first trade meeting predefined criteria obtained from the respective second trader, and wherein in step (v) said facilitating further includes facilitating, using the second smart contract, the determination, for each second trader associated with the first trader, whether the first trade meets the predefined criteria obtained from the respective second trader.

90. The method of claim 88 wherein one or more of the second traders are each associated with one or more third traders, and wherein upon facilitating execution of a second trade for a second trader, steps (i) to (v) are repeated with the second trader now being the first trader and the one or more third traders now being the one or more second traders.

91. The method of claim 88 further comprising using the second smart contract to register the one or more second traders to copy trades of the first trader.

92. The method of claim 91 wherein the second smart contract registers a given second trader only upon obtaining value from the given second trader.

93. The method of claim 88 further comprising using the second smart contract to provide value to the first trader upon the execution of one or more second trades.

94. The method of claim 92 wherein said value is in the form of cryptocurrency.

95. The method of claim 88 wherein the first smart contract and the second smart contract are the same smart contract.

96. A computer configured for facilitating automatic trading of financial instruments in a computerized trading network in which trades are recorded to a blockchain data structure and in which each trader is associated with one or more blockchain addresses, comprising:
a memory; and
a processor operatively coupled to the memory and configured to:
i) obtain from the memory data indicative of a first trader;
ii) obtain data indicative of at least one blockchain address associated with the first trader;
iii) facilitate execution of a first trade for the first trader, said facilitate including using a first smart contract to record the first trade to the blockchain data structure in association with the blockchain address of the first trader;
iv) facilitate, using the first smart contract, the determination of one or more second traders which are associated with the first trader; and
v) facilitate, using a second smart contract associated with the blockchain data structure, for each of said second traders, the automatic execution of a respective second trade and the recording of each respective second trade to the blockchain data structure in association with a blockchain address of the respective second trader.

97. The computer of claim 96 wherein the automatic execution of a respective second trade is performed only upon the first trade meeting predefined criteria obtained from the respective second trader, and wherein in step (v) said facilitate further includes to facilitate the determination, for each second trader associated with the first trader, whether the first trade meets the predefined criteria obtained from the respective second trader.

98. The computer of claim 96 wherein one or more of the second traders are each associated with one or more third traders, and wherein upon the execution of a second trade for a second trader, said processor is configured to repeat steps (i) to (v) with the second trader now being the first trader and the one or more third traders now being the one or more second traders.

99. The computer of any of claim 96 wherein said processor is further configured to use the second smart contract to register the one or more second traders to copy trades of the first trader.

100. The computer of claim 99 wherein the second smart contract registers a given second trader only upon obtaining value from the given second trader.

101. The computer of claim 96 wherein said processor is further configured to use the second smart contract to provide value to the first trader upon the execution of a second trade.

102. The computer of claim 100 wherein said value is in the form of cryptocurrency.

103. The computer of claim 92 wherein said first smart contract and said second smart contract are the same smart contract.

104. A computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising:
i) obtaining from the memory data indicative of a first trader;
ii) obtaining data indicative of at least one blockchain address associated with the first trader;
iii) facilitating execution of a first trade for the first trader, said facilitating including using a first smart contract to record the first trade to the blockchain data structure in association with the blockchain address of the first trader;
iv) facilitating, using the first smart contract, the determination of one or more second traders which are associated with the first trader; and
v) facilitating, using a second smart contract associated with the blockchain data structure, for each of said second traders, the automatic execution of a respective second trade and the recording of each respective second trade to the blockchain data structure in association with a blockchain address of the respective second trader.

105. The computer program product of claim 104 wherein the automatic execution of a respective second trade is performed only upon the first trade meeting predefined criteria obtained from the respective second trader, and wherein in step (v) said facilitating further includes facilitating, using the second smart contract, the determination, for each second trader associated with the first trader, whether the first trade meets the predefined criteria obtained from the respective second trader.

106. The computer program product of claim 104 wherein one or more of the second traders are each associated with one or more third traders, wherein upon facilitating execution of a second trade for a second trader, steps (i) to (v) are repeated with the second trader now being the first trader and the one or more third traders now being the one or more second traders.

107. The computer program product of claim 104, wherein the method further comprises using the second smart contract to register the one or more second traders to copy trades of the first trader.

108. The computer program product of claim 107 wherein the second smart contract registers a given second trader only upon obtaining value from the given second trader.

109. The computer program product of claim 104 wherein the method further comprises using the second smart contract to provide value to the first trader upon the execution of one or more second trades.

110. The computer program product of claim 108 wherein the value is in the form of cryptocurrency.

111. The computer program product of claim 104 wherein the first smart contract and the second smart contract are the same smart contract.

112. A computer-implemented method of facilitating automatic trading of financial instruments in a computerized trading network in which trades are recorded to a blockchain data structure and in which each trader is associated with one or more blockchain addresses, the method comprising, by a processor operatively coupled to a memory:
i) obtaining from the memory data indicative of a first trader;
ii) obtaining data indicative of at least one blockchain address associated with the first trader;
iii) facilitating execution of a first trade for the first trader, said facilitating including using a first smart contract to record the first trade to the blockchain data structure in association with the blockchain address of the first trader;
iv) facilitating, using the first smart contract, the determination of one or more second traders which are associated with the first trader; and
v) facilitating, using a second smart contract associated with the blockchain data structure, the automatic execution of a respective second trade for each of said second traders, and recording of the respective second trade to the blockchain data structure in association with a blockchain address of the respective second trader.

113. The method of claim 112 wherein facilitating, using the first smart contract, includes facilitating, for each respective second trader associated with the first trader, the determination of whether the first trade meets respective predefined criteria obtained from the respective second trader, and wherein facilitating, using the second smart contract is performed only in respect of second traders in respect of whom said criteria are met.

114. The method of claim 112 wherein one or more of the second traders are each associated with one or more third traders, and wherein upon facilitating execution of a second trade for a second trader, steps (i) to (v) are repeated with the second trader now being the first trader and the one or more third traders now being the one or more second traders.

115. The method of claim 112 further comprising using the second smart contract to register the one or more second traders to copy trades of the first trader.

116. The method of claim 115 wherein the second smart contract registers a given second trader only upon obtaining value from the given second trader.

117. The method of claim 112 further comprising using the second smart contract to provide value to the first trader upon the execution of one or more second trades.

118. The method of claim 116 or 11 wherein said value is in the form of cryptocurrency.

119. The method of claim 112 wherein the first smart contract and the second smart contract are the same smart contract.

120. A computer configured for facilitating automatic trading of financial instruments in a computerized trading network in which trades are recorded to a blockchain data structure and in which each trader is associated with one or more blockchain addresses, comprising:
a memory; and
a processor operatively coupled to the memory and configured to:
i) obtain from the memory data indicative of a first trader;
ii) obtain data indicative of at least one blockchain address associated with the first trader;
iii) facilitate execution of a first trade for the first trader, said facilitate including using a first smart contract to record the first trade to the blockchain data structure in association with the blockchain address of the first trader;
iv) facilitate, using the first smart contract, the determination of one or more second traders which are associated with the first trader; and
v) facilitate, using a second smart contract associated with the blockchain data structure, the automatic execution of a respective second trade for each of said second traders, and recording of the respective second trade to the blockchain data structure in association with a blockchain address of the respective second trader.

121. The computer of claim 120 wherein said facilitate, using the first smart contract, includes facilitate, for each respective second trader associated with the first trader, the determination of whether the first trade meets respective predefined criteria obtained from the respective second trader, and wherein facilitate, using the second smart contract is performed only respect of second traders in respect of whom said criteria are met.

122. The computer of claim 120 wherein one or more of the second traders are each associated with one or more third traders, and wherein upon the execution of a second trade for a second trader, said processor is configured to repeat steps (i) to (v) with the second trader now being the first trader and the one or more third traders now being the one or more second traders.

123. The computer of any of claim 120 wherein said processor is further configured to use the second smart contract to register the one or more second traders to copy trades of the first trader.

124. The computer of claim 123 wherein the second smart contract registers a given second trader only upon obtaining value from the given second trader.

125. The computer of claim 120 wherein said processor is further configured to use the second smart contract to provide value to the first trader upon the execution of a second trade.

126. The computer of claim 124 wherein said value is in the form of cryptocurrency.

127. The computer of claim 120 wherein said first smart contract and said second smart contract are the same smart contract.

128. A computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising:
i) obtaining from the memory data indicative of a first trader;
ii) obtaining data indicative of at least one blockchain address associated with the first trader;
iii) facilitating execution of a first trade for the first trader, said facilitating including using a first smart contract to record the first trade to the blockchain data structure in association with the blockchain address of the first trader;
iv) facilitating, using the first smart contract, the determination of one or more second traders which are associated with the first trader; and
v) facilitating, using a second smart contract associated with the blockchain data structure, the automatic execution of a respective second trade for each of said second traders, and recording of the respective second trade to the blockchain data structure in association with a blockchain address of the respective second trader.

129. The computer program product of claim 128 wherein facilitating, using the first smart contract, includes facilitating, for each respective second trader associated with the first trader, the determination of whether the first trade meets respective predefined criteria obtained from the respective second trader, and wherein facilitating, using the second smart contract is performed only in respect of second traders in respect of whom said criteria are met.

130. The computer program product of claim 128 wherein one or more of the second traders are each associated with one or more third traders, wherein upon facilitating execution of a second trade for a second trader, steps i) to v) are repeated with the second trader now being the first trader and the one or more third traders now being the one or more second traders.

131. The computer program product of claim 128, wherein the method further comprises using the second smart contract to register the one or more second traders to copy trades of the first trader.

132. The computer program product of claim 131 wherein the second smart contract registers a given second trader only upon obtaining value from the given second trader.

133. The computer program product of claim 128 wherein the method further comprises using the second smart contract to provide value to the first trader upon the execution of one or more second trades.

134. The computer program product of claim 132 wherein the value is in the form of cryptocurrency.

135. The computer program product of claim 128 wherein the first smart contract and the second smart contract are the same smart contract.

136. A computer-implemented method of facilitating automatic trading of financial instruments in a computerized trading network in which trades are recorded to a blockchain data structure and in which each trader is associated with one or more blockchain addresses, the method comprising, by a processor operatively coupled to a memory:
i) obtaining from the memory data indicative of a first trader;
ii) obtaining data indicative of at least one blockchain address associated with the first trader;
iii) facilitating execution of a first trade for the first trader, said facilitating including using a smart contract to record the first trade to the blockchain data structure in association with the blockchain address of the first trader; and
iv) facilitating, using the smart contract, the determination of one or more second traders which are associated with the first trader and, for each of said second traders, the automatic execution of a respective second trade and the recording of each respective second trade to the blockchain data structure in association with a blockchain address of the respective second trader.

137. The method of claim 136 wherein the automatic execution of a respective second trade is performed only upon the first trade meeting predefined criteria obtained from the respective second trader, and wherein in step (iv) said facilitating further includes facilitating, using the smart contract, the determination, for each second trader associated with the first trader, whether the first trade meets the predefined criteria obtained from the respective second trader.

138. The method of claim 136 wherein one or more of the second traders are each associated with one or more third traders, and wherein upon facilitating execution of a second trade for a second trader, steps (i) to (iv) are repeated with the second trader now being the first trader and the one or more third traders now being the one or more second traders.

139. The method of claim 136 further comprising using the smart contract to register the one or more second traders to copy trades of the first trader.

140. The method of claim 139 wherein the smart contract registers a given second trader only upon obtaining value from the given second trader.

141. The method of claim 136 further comprising using the smart contract to provide value to the first trader upon the execution of one or more second trades.

142. The method of claim 140 wherein said value is in the form of cryptocurrency.

143. A computer configured for facilitating automatic trading of financial instruments in a computerized trading network in which trades are recorded to a blockchain data structure and in which each trader is associated with one or more blockchain addresses, comprising:
a memory; and
a processor operatively coupled to the memory and configured to:
i) obtain from the memory data indicative of a first trader;
ii) obtain data indicative of at least one blockchain address associated with the first trader;
iii) facilitate execution of a first trade for the first trader, said facilitate including using a smart contract to record the first trade to the blockchain data structure in association with the blockchain address of the first trader; and
iv) facilitate, using the smart contract, the determination of one or more second traders which are associated with the first trader and, for each of said second traders, the automatic execution of a respective second trade and the recording of each respective second trade to the blockchain data structure in association with a blockchain address of the respective second trader.

144. The computer of claim 143 wherein the automatic execution of a respective second trade is performed only upon the first trade meeting predefined criteria obtained from the respective second trader, and wherein in step (iv) said facilitate further includes to facilitate the determination, for each second trader associated with the first trader, whether the first trade meets the predefined criteria obtained from the respective second trader.

145. The computer of claim 143 wherein one or more of the second traders are each associated with one or more third traders, and wherein upon the execution of a second. trade for a second trader, said processor is configured to repeat steps (i) to (iv) with the second trader now being the first trader and the one or more third traders now being the one or more second traders.

146. The computer of claim 143 wherein said processor is further configured to use the smart contract to register the one or more second traders to copy trades of the first trader.

147. The computer of claim 146 wherein the smart contract registers a given second trader only upon obtaining value from the given second trader.

148. The computer of claim 143 wherein said processor is further configured to use the smart contract to provide value to the first trader upon the execution of a second trade.

149. The computer of claim 147 wherein said value is in the form of cryptocurrency.

150. A computer program product containing a sequence of instructions that when implemented by a processor causes the processor to perform a method of facilitating automatic trading of financial instruments in a computerized trading network in which trades are recorded to a blockchain data structure and in which each trader is associated with one or more blockchain addresses, the method comprising:
i) obtaining from the memory data indicative of a first trader;
ii) obtaining data indicative of at least one blockchain address associated with the first trader;
iii) facilitating execution of a first trade for the first trader, said facilitating including using a smart contract to record the first trade to the blockchain data structure in association with the blockchain address of the first trader; and
iv) facilitating, using the smart contract, the determination of one or more second traders which are associated with the first trader and, for each of said second traders, the automatic execution of a respective second trade and the recording of each respective second trade to the blockchain data structure in association with a blockchain address of the respective second trader.

151. The computer program product of claim 150 wherein the automatic execution of a respective second trade is performed only upon the first trade meeting predefined criteria obtained from the respective second trader, and wherein in step (iv) said facilitating further includes facilitating, using the smart contract, the determination, for each second trader associated with the first trader, whether the first trade meets the predefined criteria obtained from the respective second trader.

152. The computer program product of claim 150 wherein one or more of the second traders are each associated with one or more third traders, wherein upon facilitating execution of a second trade for a second trader, steps (i) to (iv) are repeated with the second trader now being the first trader and the one or more third traders now being the one or more second traders.

153. The computer program product of claim 150, wherein the method further comprises using the smart contract to register the one or more second traders to copy trades of the first trader.

154. The computer program product of claim 153 wherein the smart contract registers a given second trader only upon obtaining value from the given second trader.

155. The computer program product of claim 150 wherein the method further comprises using the smart contract to provide value to the first trader upon the execution of one or more second trades.

156. The computer program product of claim 154 wherein the value is in the form of cryptocurrency.
